(19) United States
(12) Patent Application Publication
(10) Pub. No.: US 2004/0263234 A1
(43) Pub. Date: Dec. 30, 2004

(54) ARRANGEMENT, NETWORK AND METHOD FOR REDUCING NON-LINEARITY WITHIN ACTIVE RESISTOR NETWORKS

(75) Inventor: James S. Mason, Eastleigh, Hampshire (GB)

Correspondence Address: INTERNATIONAL BUSINESS MACHINES CORPORATION, DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 10/604,105

(22) Filed: Jun. 26, 2003

(51) Int. Cl. G06F 1/00

(52) U.S. Cl. 327/334

(57) ABSTRACT

A compensation arrangement, having a first FET (220) having a non-linear response as an active resistor and a second FET (240) having a non-linear response coupled to the first FET (220), reduces non-linearity in an active resistor network. The non-linear response of the second FET (240) is adapted in order to compensate for the non-linear response of the first FET (220). The two FETs (220, 240) are complementary, and are selected to achieve the desired overall resistance value of the network. In this way the arrangement substantially reduces non-linear performance with an applied voltage, and is well suited for high frequency applications.

### BACKGROUND OF INVENTION

This invention relates to active resistor networks in integrated circuits, and particularly, but not exclusively, to such active resistor networks in which a transistor such as an Field Effect Transistor (FET) is used to simulate a resistor.

In the field of this invention it is known that an FET can be used to model a resistor by operating the device within its ohmic region. There are many circuit applications where this can be desirable, for example in integrated circuit design processes where resistors are not available. In this mode of operation, the FET also provides an advantage in that the value of resistance can also be varied to some extent by controlling the gate bias. This facilitates other applications such as the control of circuit performance (for example, variable gain amplifiers) or to regulate the value of resistance provided by a network.

A well known problem with this arrangement is the so-called resistor non-linearity (resistance change with applied voltage, typically Vds). When an active resistor is operated away from the bias conditions of the feedback system reference device, in other words when the voltage across the active resistor is different from that applied across the reference, then the resistor value will change. A FET biased in its ohmic region does not exhibit a true linear relationship between current and voltage and so as the voltage across the device alters then so will the resulting resistance.

Various techniques are known which may mitigate the non-linear behaviour of the FET in this operating region, such as selecting an appropriate device geometry and bias condition, but the effect cannot be removed.

In applications where there is a significant change in voltage across the resistor, this non-linearity can cause a substantial impediment to the accuracy of the resistance, and hence the performance of its associated circuitry.

U.S. Pat. No. 5,793,254 describes a system for controlling an FET to simulate a resistor, which in this case is used to set feedback across an amplifier. However, although this patent suggests that the size of this FET device should be chosen to optimise its performance, and notes that variations in the resistance of the feedback element due to variations in process, temperature, and power supply voltage can affect its performance, it does not address the issue of non-linearity due to changing voltage across the FET device itself. Although the patent describes the addition of a pole-zero circuit which compensates for both the linear and non-linear characteristics of the feedback circuit, it does not directly address one of the most significant non-linear factors, i.e., the change in resistance of the feedback circuit with changing applied voltage across it.

In some applications, the voltage variation can be very significant, for example in termination networks for transmission lines or radio frequency circuits, when the signal may oscillate between zero and its full signal amplitude. The use of FETs for termination in these applications is attractive for integrated circuit applications but the non-linear performance of the device is a strong disincentive.

A need therefore exists for an arrangement, network and method for reducing non-linearity within active resistor networks wherein the abovementioned disadvantages may be alleviated.

### SUMMARY OF INVENTION

The invention provides an arrangement, network and method for reducing non-linearity within active resistor networks in which non-linear performance with an applied voltage is substantially reduced.

In accordance with a first aspect, the invention provides an arrangement for reducing non-linearity within an active resistor network, comprising a first active device adapted to provide resistance of a desired resistor, the first active device having a non-linear response; and a second active device coupled to the first active device, the second active device having a non-linear response adapted to compensate substantially for the non-linear response of the first active device.

In accordance with a second aspect, the invention provides an active resistor network comprising the above arrangement.

In accordance with a third aspect, the invention provides a method for reducing non-linearity within an active resistor network, comprising providing a first active device adapted to provide resistance of a resistor, the first active device having a non-linear response; and providing a second active device coupled to the first active device, the second active device having a non-linear response adapted to compensate substantially for the non-linear response of the first active device.

The first active device is preferably coupled to receive control signals for regulating the resistance of the arrangement. Preferably, the second active device is coupled to receive control signals for regulating the resistance of the arrangement. Preferably, one of the first and second active devices is a p-type device and the other of the first and second active devices is an n-type device. The first and second active devices are preferably complementary metal oxide semiconductor (CMOS) devices. Preferably, the first and second active devices are provided with minimum dimensions for optimal high frequency performance. Preferably, the first and second active devices are tuned using an optimization algorithm. Alternatively, the first and second active devices are preferably tuned using a manual tuning technique.

These and other aspects of the invention are described in further detail below.

### BRIEF DESCRIPTION OF DRAWINGS

FIG. 1 shows a block-schematic circuit diagram illustrating a prior art active resistor network utilising a control FET and a reference FET.

FIG. 2 shows a block-schematic circuit diagram illustrating an active resistor network provided with compensation in accordance with a preferred embodiment of the present invention.

FIG. 3 shows a graph illustrating performance of the arrangement of FIG. 2 with and without compensation.

### DETAILED DESCRIPTION

One arrangement, network and method for reducing non-linearity within active resistor networks incorporating the present invention will now be described, by way of example only, with reference to the accompanying drawings.

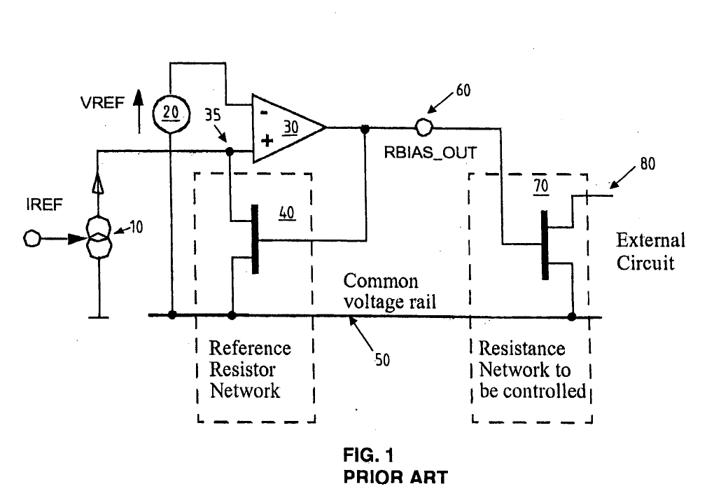

Referring to FIG. 1, there is shown a prior art circuit diagram of a basic active resistor control system. A reference resistor element is formed by an N-type FET (NFET) 40, which has a gate electrode driven by the output of a differential amplifier 30.

The differential amplifier 30 also has a non-inverting input coupled via node 35 to a current reference source 10 and an inverting input coupled to a voltage reference source 20. In this way it forms a closed loop controller.

A drain electrode of the NFET 40 is coupled to the node 35, and a source electrode of the NFET 40 is coupled to a common voltage rail 50. The system acts to control the resistance provided by the NFET 40 such that the voltage at its drain electrode (node 35) equals Vref when the drain current is Iref. Consequently, the resistance presented by the NFET 40 is equal to Vref/Iref and the controller output 60 (RBIAS_OUT) can be used to control other networks.

A slave network is formed by an NFET 70, having a gate electrode coupled to the controller output 60, a source electrode coupled to the common voltage rail 50 and a drain electrode coupled to a node 80.

Ignoring matching issues, the resistance presented by the NFET 70 will also be Vref/Iref if the voltage at node 80 is equal to that at node 35. As the voltage at node 80 moves away from that at node 35, an error will be introduced between the resistor values presented by the two networks due to the non-linear behaviour of the NFETs 40 and 70 respectively, when operated within their ohmic region.

As the voltage at node 80 increases beyond that at node 35, the operating point for NFET 70 will move towards the saturation region and the resistance presented by the channel will increase. Similarly, reducing the voltage at node 80 below that at node 35 will tend to reduce the resistance.

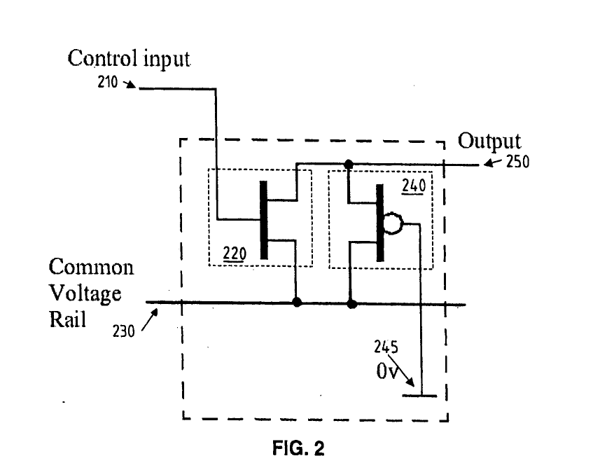

Referring now also to FIG. 2, there is shown a circuit diagram of a compensation arrangement according to the invention.

An NFET 220 has a gate electrode coupled to a control input 210, a drain electrode and a source electrode coupled to a common voltage rail 230.

A PFET 240 has a gate electrode coupled to a fixed bias voltage 245 (in this case 0V) relative to the common voltage rail 230, a drain electrode coupled between the drain electrode of the NFET 220 and an output node 250 and a source electrode coupled to the common voltage rail 230.

The inclusion of the second FET, the PFET 240, is designed to counteract and thus substantially compensate for the non-linearity of the NFET 220.

In this case as the voltage at the output 250 increases, resulting in the channel resistance of the NFET 220 increasing, the gate to source voltage of the PFET 240 increases, thereby reducing its channel resistance and providing a compensating effect in the opposite direction.

Since active termination resistors are often connected to a common rail voltage such as the rail 230, this can be used to precisely set the gate and source voltage for the compensating device, in this case the PFET 240. Since the NFET 220 and PFET 240 are complementary devices built in a Complementary Metal Oxide Semiconductor (CMOS) process, their parameters will track to a substantially large degree. Consequently, once the network has been designed, it is possible to control the NFET 220 through a feedback control arrangement (not shown), coupled between the output 250 and the control input 210, in order to regulate the resistance of the overall network.

Alternatively, the feedback control arrangement (not shown) could also be coupled to the fixed bias voltage 245, in order that the PFET 240 also be regulated, in conjunction with the NFET 220, in order to regulate the resistance of the overall network.

The PFET 240 provides the compensation for the non-linearity introduced by the changing drain-source voltage across both FET devices. The size of the NFET 220 and the PFET 240 (width and length of their channels) are chosen to optimise the non-linear performance of the network.

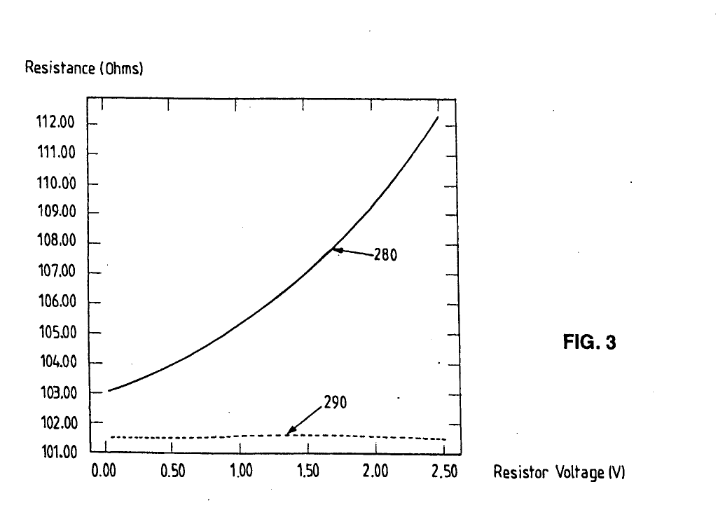

A practical example of the compensation that can be achieved is illustrated by the graph of FIG. 3, which shows how the output resistance (Y-Axis) of a FET can change as the output voltage (X-Axis) moves away from the common rail voltage.

Normally the set point for the closed loop controller (the voltage at node 35 in the example shown in FIG. 1) would nominally be set midway along the operating voltage range of the resistor. In the first case (curve 280), with an uncompensated network, a significant deviation can be observed in the resistance variation with voltage. Using an appropriately designed network such as that proposed in FIG. 2, this can be significantly improved as shown in the curve 290.

It will be understood that alternative embodiments to that described above are possible. For example, a PFET device could be used as the control element with an NFET device used as the compensation element. However, the basic principle would be the same in all cases, i.e., the adoption of a second device to introduce the non-linearity in the opposite direction to the first device.

The FETs used within the network need to track each other in parametric performance, this solution is ideally suited for integrated circuit applications where device matching is assured.

The two FET sizes need to be selected to achieve both the desired overall resistance value of the network and also to minimise the non-linear effect due to applied voltage across the network. Computer-based optimisation programmes can be used to tune the device sizes for the required performance. Such techniques are well known within circuit design, for example genetic algorithm and simulated annealing are two examples of optimisation techniques that could be used for this problem. Alternatively the network could be manually tuned.

In practice, the device sizes should be minimised for best high frequency performance (there is some trade off between high performance and accuracy, but this is also true for the single FET performance).

Minimising devices sizes, subject to the accuracy constraint, also has the obvious advantage of reducing the area occupied by the network resulting in a more efficient design for IC implementation.

It will also be appreciated that it is also possible to correct for the non-linearity by applying control through the gate voltage of a single device. However, for high frequency applications this would not be a practical solution. The invention described here effectively uses DC control of both gate voltages, a feedback system can be conveniently used to regulate the resistance of the overall network. This approach is convenient for resistors that need to operate at high frequencies.

The same principle could be used for a digitally controlled system. The basic two FET network could be reproduced with binary weights to the required accuracy. In this case, each weighted network could be controlled by a bit of the binary control bus.

It will also be appreciated that the preferred embodiment described above is particularly suited for active resistor networks which need to operate at high frequencies, for example transmission line terminators, since the additional parasitic capacitance introduced by the compensation device is minimal.

In conclusion, it will be understood that the arrangement, network and method described above provide the following advantages: (i) it addresses the non-linear performance with applied voltage (Vds) for FETs operated in the ohmic region; and (ii) it is well suited for high frequency applications as it requires only one extra device and both gates only require a DC bias.

1-16. (canceled)

17. A method for reducing non-linearity within an active resistor network, comprising:
providing a first active device adapted to provide resistance of a desired resistor, the first active device having a non-linear response, said first active device being coupled to receive a first control signal for regulating the resistance of said arrangement; and
providing a second active device coupled to the first active device, the second active device having a non-linear response adapted to compensate substantially for the non-linear response of the first active device, said second active device being coupled to receive a second control signal for regulating the resistance of said arrangement.

18-19. (canceled)

20. The method of claim 17 wherein one of said first and said second active devices is a p-type device and the other of said first and said second active devices is an n-type device.

21. The method of claim 20 wherein said first and said second active devices are CMOS devices.

22. The method of claim 21 wherein said first and said second active devices are provided with minimum dimensions for optimal high frequency performance.

23. The method of claim 22 wherein said first and said second active devices are tuned using an optimisation algorithm.

24. The method of claim 22 wherein said first and said second active devices are tuned using a manual tuning technique.
